(19) United States
(12) Patent Application Publication
(10) Pub. No.: US 2026/0112315 A1
(43) Pub. Date: Apr. 23, 2026

(54) DISPLAY DEVICE AND METHOD OF DRIVING THE SAME, AND ELECTRONIC DEVICE

(71) Applicant: Samsung Display Co., LTD., Yongin-si, Gyeonggi-do (KR)

(72) Inventors: Jung Eon AN, Yongin-si (KR); Ki Hyun PYUN, Yongin-si (KR)

(21) Appl. No.: 19/324,520

(22) Filed: Sep. 10, 2025

(30) Foreign Application Priority Data
Oct. 21, 2024 (KR) 10-2024-0144178

(51) Int. Cl. G09G 3/3233; G09G 3/32

(52) U.S. Cl. CPC G09G 3/3233; G09G 3/32; G09G 2300/043; G09G 2310/08; G09G 2330/023

(57) ABSTRACT

A display device includes: a display unit including pixels connected to a first power line, a second power line, scan lines, and data lines; a sensing resistor between the first power line and the display unit, or between the second power line and the display unit; a current sensor to measure a global current value flowing through the sensing resistor; a timing controller to generate a voltage code based on input data; and a power generator including a DC-to-DC converter to generate a first driving power source to be supplied to the first power line, based on the voltage code. The timing controller is further to compare the voltage code with a threshold voltage code, and the power generator is to control a switching frequency of the DC-to-DC converter based on a comparison result of the voltage code and the threshold voltage code.

### CROSS-REFERENCE TO RELATED APPLICATION

The present application claims priority to and the benefit of Korean Patent Application No. 10-2024-0144178, filed on Oct. 21, 2024, in the Korean Intellectual Property Office, the entire disclosure of which is incorporated by reference herein.

### BACKGROUND

### 1. Field

Aspects of embodiments of the present disclosure relate to a display device, a method of driving the display device, and an electronic device.

### 2. Description of the Related Art

With the development of information technology, the importance of a display device, which is a connection medium between a user and information, is increasing. Accordingly, display devices are increasingly being used, such as a liquid crystal display device and an organic light emitting display device.

A display device includes pixels. The pixels emit light having a luminance (e.g., a predetermined luminance) corresponding to a driving current flowing from a first driving power source to a second driving power source via a light emitting element, thereby displaying an image (e.g., a predetermined image).

The above information disclosed in this Background section is for enhancement of understanding of the background of the present disclosure, and therefore, it may contain information that does not constitute prior art.

### SUMMARY

A voltage value of the first driving power source may be changed corresponding to a load of a display unit (e.g., a display panel) and a peak grayscale (e.g., a peak grayscale value or level). As an example, a voltage value of the first driving power source in a pth frame (where p is a natural number of 1 or more) may be determined corresponding to a load of the display unit and a peak grayscale (e.g., a peak grayscale value or level) in a (p-1)th frame. When a voltage of the first driving power source in a current frame is determined by a load of the display unit and a peak grayscale (e.g., a peak grayscale value or level) in a previous frame (e.g., when a voltage of the first driving power source is delayed in one frame unit to be reflected), the driving current may exceed a limit current value.

Embodiments of the present disclosure may be directed to a display device, a method of driving the display device, and an electronic device, which may ensure a stability of the driving.

According to one or more embodiments of the present disclosure, a display device includes: a display unit including pixels connected to a first power line, a second power line, scan lines, and data lines; a sensing resistor between the first power line and the display unit, or between the second power line and the display unit; a current sensor configured to measure a global current value flowing through the sensing resistor; a timing controller configured to generate a voltage code based on input data; and a power generator including a DC-to-DC converter configured to generate a first driving power source to be supplied to the first power line, based on the voltage code. The timing controller is further configured to compare the voltage code with a threshold voltage code, and the power generator is configured to control a switching frequency of the DC-to-DC converter based on a comparison result of the voltage code and the threshold voltage code.

In an embodiment, the power generator may be configured to drive the DC-to-DC converter at a first switching frequency when the voltage code is the threshold voltage code or higher, and the power generator may be configured to drive the DC-to-DC converter at a second switching frequency different from the first switching frequency when the voltage code is lower than the threshold voltage code.

In an embodiment, the second switching frequency may be higher than the first switching frequency.

In an embodiment, the threshold voltage code may correspond to a voltage value of 80% or more when a highest voltage value of the first driving power source supplied from the power generator is 100%.

In an embodiment, the timing controller may include: an analyzer configured to extract a load of the input data and a peak grayscale; a code value generator configured to generate the voltage code corresponding to the load and the peak grayscale; and a controller configured to compare the voltage code with the threshold voltage code, and generate a control signal based on the comparison result.

In an embodiment, the analyzer may include: a load analyzer configured to calculate the load of the input data; and a grayscale analyzer configured to extract the peak grayscale from the input data.

In an embodiment, the current sensor may be configured to supply an alarm signal to the code value generator when the global current value exceeds a limit current value.

In an embodiment, the code value generator may be configured to decrease a voltage of the first driving power source when the alarm signal is input from the current sensor.

In an embodiment, the controller may be configured to: generate a first level control signal when the voltage code is the threshold voltage code or higher; and generate a second level control signal when the voltage code is lower than the threshold voltage code.

In an embodiment, the power generator may include: a digital-to-analog converter configured to generate a reference voltage corresponding to the voltage code; the DC-to-DC converter configured to generate the first driving power source based on the reference voltage; a first resistor, and a second resistor having a lower resistance value as compared with that of the first resistor; and a selector configured to electrically connect the first resistor to the DC-to-DC converter or the second resistor to the DC-to-DC converter corresponding to the first level control signal or the second level control signal.

In an embodiment, the selector may be configured to electrically connect the first resistor to the DC-to-DC converter when the first level control signal is input, and the DC-to-DC converter may be configured to be driven at a first switching frequency when the first resistor is connected thereto.

In an embodiment, the selector may be configured to electrically connect the second resistor to the DC-to-DC converter when the second level control signal is input, and the DC-to-DC converter may be configured to be driven at a second switching frequency higher than the first switching frequency when the second resistor is connected thereto.

According to one or more embodiments of the present disclosure, a method of driving a display device, includes: generating a voltage code corresponding to a load of input data and a peak grayscale; comparing the voltage code with a threshold voltage code; generating a first level control signal or a second level control signal based on a comparison result of the voltage code with the threshold voltage code; and generating, by a DC-to-DC converter, a first driving power source corresponding to the voltage code at different switching frequencies corresponding to the first level control signal or the second level control signal.

In an embodiment, the threshold voltage code may correspond to a voltage value of 80% or more when a highest voltage value of the first driving power source is 100%.

In an embodiment, the first level control signal may be generated when the voltage code is the threshold voltage code or higher, and the second level control signal may be generated when the voltage code is lower than the threshold voltage code.

In an embodiment, the DC-to-DC converter may be configured to be driven at a first switching frequency when the first level control signal is input, and the DC-to-DC converter may be configured to be driven at a second switching frequency when the second level control signal is input.

In an embodiment, the second switching frequency may be higher than the first switching frequency.

In an embodiment, the DC-to-DC converter may be configured to be electrically connected to a first resistor when the first level control signal is input, and the DC-to-DC converter may be configured to be electrically connected to a second resistor when the second level control signal is input, the second resistor having a resistance value lower than a resistance value of the first resistor.

According to one or more embodiments of the present disclosure, an electronic device includes: a display panel including pixels; a DC-to-DC converter configured to supply a first driving power source to the display panel based on a voltage code; and a controller configured to generate the voltage code based on input data. The controller is further configured to compare the voltage code with a threshold voltage code, and a switching frequency of the DC-to-DC converter is changed based on a comparison result of the voltage code and the threshold voltage code.

In an embodiment, the DC-to-DC converter may be configured to be driven at a first switching frequency when the voltage code is the threshold voltage code or higher, the DC-to-DC converter may be configured to be driven at a second switching frequency when the voltage code is lower than the threshold voltage code, and the second switching frequency may be higher than the first switching frequency.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1 is a diagram illustrating a display device in accordance with an embodiment of the present disclosure.

FIG. 2 is a diagram illustrating a pixel shown in FIG. 1 in accordance with an embodiment of the present disclosure.

FIG. 3 is a diagram illustrating a first driving power source generated corresponding to a voltage code by a power generator in accordance with an embodiment of the present disclosure.

FIG. 4 illustrates an example of a specific pattern that is displayed on a display unit.

FIG. 5 is a diagram illustrating a driving current and a consumed power when a DC-to-DC converter included in the power generator is driven at a high driving frequency.

FIG. 6 is a diagram illustrating a timing controller and a power generator in accordance with an embodiment of the present disclosure.

FIG. 7 is a diagram illustrating a driving current and a consumed power when the DC-to-DC converter is driven at a first switching frequency.

FIG. 8 is a diagram illustrating an electronic device in accordance with an embodiment of the present disclosure.

FIGS. 9-12 are views illustrating electronic devices in accordance with various embodiments of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. For example, the expression “equal” may mean “substantially equal. ” In other words, equal or substantially equal may mean an equality to a degree to which those skilled in the art may understand the equality. Other expressions may be expressions in which “substantially” is omitted. Further, the use of “may” when describing embodiments of the present disclosure refers to “one or more embodiments of the present disclosure. ” As used herein, the terms “use,” “using,” and “used” may be considered synonymous with the terms “utilize,” “utilizing,” and “utilized,”respectively.

Some embodiments are described with reference to the accompanying drawings in relation to functional blocks, units, and/or modules. Those skilled in the art will understand that these blocks, units, and/or modules may be physically implemented by logic circuits, individual components, microprocessors, hard wire circuits, memory elements, line connection, and/or other electronic circuits. They may be formed by using semiconductor-based manufacturing techniques or other manufacturing techniques. In the case of blocks, units, and/or modules implemented by microprocessors or other similar hardware, the units, and/or modules may be programmed and controlled by using software, to perform various functions discussed in the present disclosure, and may be selectively driven by firmware and/or software. In addition, each block, each unit, and/or each module may be implemented by dedicated hardware, or by a combination of dedicated hardware to perform some functions of the block, the unit, and/or the module, and a processor (e.g., one or more programmed microprocessors and associated circuitry) to perform other functions of the block, the unit, and/or the module. In some embodiments, the blocks, the units, and/or the modules may be physically separated into two or more individual blocks, two or more individual units, and/or two or more individual modules. Also, in some embodiments, the blocks, the units, and/or the modules may be physically separated into more complex blocks, more complex units, and/or more complex modules.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

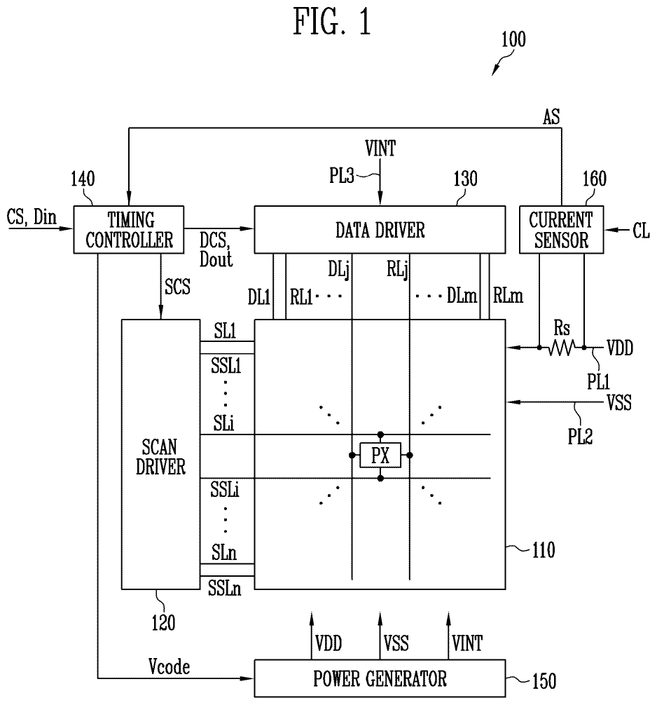

FIG. 1 is a diagram illustrating a display device in accordance with an embodiment of the present disclosure.

Referring to FIG. 1, a display device 100 in accordance with an embodiment of the present disclosure may include a display unit 110 (e.g., a display panel), a scan driver 120, a data driver 130, a timing controller 140, a power generator 150, and a current sensor 160. The scan driver 120, the data driver 130, the timing controller 140, the power generator 150, and the current sensor 160 may constitute a driving device that drives the display unit 110.

The display unit 110 may display an image. The display unit 110 may include pixels PX connected to first scan lines SL1 to SLn, second scan lines SSL1 to SSLn, data lines DL1 to DLm, and readout lines RL1 to RLm, where n and m are natural numbers of 3 or more.

A pixel PX may be connected to one of the first scan lines SL1 to SLn and one of the data lines DL1 to DLm. Also, the pixel PX may be connected to one of the second scan lines SSL1 to SSLn and one of the readout lines RL1 to RLm.

As an example, a pixel PX located on an ith row and a jth column may be connected to an ith first scan line SLi, an ith second scan line SSLi, a jth data line DLj, and a jth readout line RLj, where i is a natural number of n or less and 1 or more, and j is a natural number of m or less and 1 or more. Also, the pixel PX may be connected to a first power line PL1 to which a first driving power source VDD is applied, and a second power line PL2 to which a second driving power source VSS is applied.

The first driving power source VDD may supply a driving current to the pixel PX, and the second driving power source VSS may be supplied with a driving current from the pixel PX. The first driving power source VDD may have a voltage higher than a voltage of the second driving power source VSS during an emission period of the pixel PX.

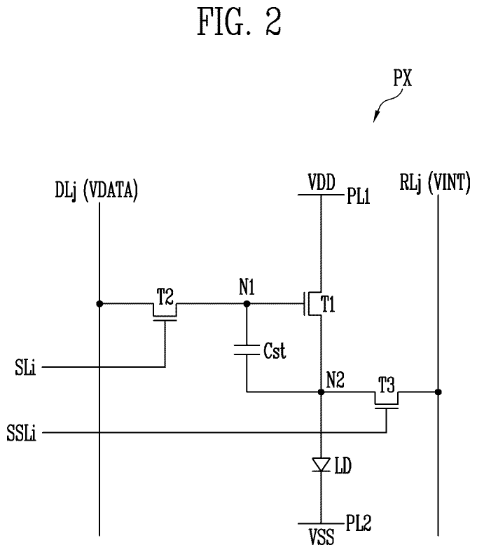

The pixel PX may be initialized by an initialization power source VINT provided through the readout line RLj in response to a second scan signal provided through the second scan line SSLi, and may be supplied with a data signal (e.g., a data voltage) through the data line DLj in response to a first scan signal provided through the first scan line SLi. The pixel PX may generate light having a luminance corresponding to the data signal, while controlling an amount of current flowing from the first driving power source VDD to the second driving power source VSS via a light emitting element LD (e.g., see FIG. 2) corresponding to the data signal. The initialization power source VINT may have (e.g., may be set to) a voltage lower than that of an operation point (e.g., a threshold voltage) of the light emitting element LD.

The scan driver 120 may generate a first scan signal and a second scan signal, based on a scan control signal SCS. The first scan signal may be sequentially supplied to the first scan lines SL1 to SLn, and the second scan signal may be sequentially supplied to the second scan lines SSL1 to SSLn.

The scan control signal SCS may include a start signal, a clock signal, and the like, and may be provided from the timing controller 140 to the scan driver 120. The scan driver 120 may be implemented as a shift register that sequentially generates and outputs the first scan signal in a pulse form by sequentially shifting the start signal, corresponding to the clock signal. Also, the scan driver 120 may generate and output the second scan signal similarly to the first scan signal. The scan driver 120 may include a first scan driver for generating the first scan signal, and a second scan driver for generating the second scan signal.

The scan driver 120 may be formed together with the pixels PX in the display unit 110. However, the present disclosure is not limited thereto. For example, the scan driver 120 may be mounted on a circuit film, and may be connected to the timing controller 140 via at least one circuit film and at least one printed circuit board.

The data driver 130 may generate a data signal (e.g., a data voltage) based on output data Dout and a data control signal DCS, which are provided from the timing controller 140, and may provide the data signal to the display unit 110 (e.g., to the pixel PX) through the data lines DL1 to DLm. The data control signal DCS may include a data enable signal, a data clock signal, and the like. The data driver 130 may provide the initialization power source VINT to the display unit 110 (e.g., to the pixel PX) through the readout lines RL1 to RLm.

In an embodiment, the data driver 130 may receive a sensing signal through the readout lines RL1 to RLm in a separate sensing period (e.g., a sensing period allocated to sense characteristic information of the pixel PX, such as a threshold voltage and/or a mobility of a driving transistor included in the pixel PX). The sensing signal may be used to compensate for a characteristic (e.g., a characteristic variation) of the pixel PX in the data driver 130 and/or the timing controller 140.

In an embodiment, the readout lines RL1 to RLm may be connected to a separate sensor. The sensor may supply a voltage of the initialization power source VINT to the display unit 110, or may receive a sensing signal through the readout lines RL1 to RLm.

The power generator 150 may supply the first driving power source VDD and the second driving power source VSS to the display unit 110. The power generator 150 may supply the initialization power source VINT to the data driver 130.

The power generator 150 may generate the first driving power source VDD having a suitable voltage (e.g., a predetermined voltage) corresponding to a voltage code Vcode supplied from the timing controller 140. The voltage of the first driving power source VDD may be determined according to (e.g., corresponding to) the voltage code Vcode.

The power generator 150 may provide a driving voltage used for driving of at least one of the scan driver 120, the data driver 130, the timing controller 140, or the current sensor 160. The power generator 150 may be implemented as a power management integrated circuit (IC) (PMIC).

The first driving power source VDD may be supplied to the display unit 110 through the first power line PL1. The second driving power source VSS may be supplied to the display unit 110 through the second power line PL2. The initialization power source VINT may be supplied to the data driver 130 through a third power line PL3. Each of the first power line PL1 and the second power line PL2 may be commonly connected to the pixels PX.

A sensing resistor Rs may be connected to the first power line PL1 that is commonly connected to the pixels PX. As an example, the sensing resistor Rs may be connected between the first power line PL1 and the display unit 110. The voltage (and the current) of the first driving power source VDD may be supplied to the display unit 110 via the sensing resistor Rs.

The current sensor 160 may be electrically connected to both ends (e.g., opposite ends) of the sensing resistor Rs. The current sensor 160 may sense a current flowing through the sensing resistor Rs, thereby generating a global current value. The current sensor 160 may compare the global current value with a limit current value (e.g., a predetermined limit current value) CL, and may generate an alarm signal AS corresponding to a comparison result. As an example, the current sensor 160 may generate the alarm signal AS, and may supply the alarm signal AS to the timing controller 140 when the global current value is equal to or exceeds (e.g., or greater than) the limit current value CL.

The global current value may correspond to a current that is commonly supplied to the pixels PX through the first power line PL. However, the present disclosure is not limited thereto. For example, the sensing resistor Rs may be connected to the second power line PL2 that is commonly connected to the pixels PX, and the current sensor 160 may sense a current flowing through the second power line PL2. In this case, the current sensor 160 may generate a global current value from the sensing resistor Rs connected to the second power line PL2.

The timing controller 140 may receive input data Din and a control signal CS from the outside (e.g., from a graphics processor, an application processor, or the like), and may generate the scan control signal SCS and the data control signal DCS based on the control signal CS.

In an embodiment, the timing controller 140 may control the voltage of the first driving power source VDD in a frame unit (e.g., in a unit of a frame), corresponding to a load of the pixels PX and a peak grayscale (e.g., a peak grayscale value or level). As an example, the timing controller 140 may generate a voltage code Vcode, such that the first driving power source VDD has a desired voltage value (e.g., a predetermined voltage value), corresponding to the load of the pixels PX and the peak grayscale.

In an embodiment, the timing controller 140 may compare a threshold voltage code (e.g., a predetermined threshold voltage code) with the voltage code Vcode, and may control a switching frequency of the power generator 150 based on a comparison result. As an example, the power generator 150 may include a DC-to-DC converter, and the timing controller 140 may control a switching frequency of the DC-to-DC converter based on the comparison result of the threshold voltage code and the voltage code Vcode.

In an embodiment, when it is determined that the voltage code Vcode (e.g., a voltage corresponding to the voltage code Vcode) is (e.g., equal to or substantially equal to) the threshold voltage code (e.g., a voltage corresponding to the threshold voltage code) or higher, the timing controller 140 may determine (e.g., may set or may adjust) the switching frequency of the DC-to-DC converter as a first frequency (e.g., a first switching frequency). The first switching frequency may be a relatively low frequency. When the DC-to-DC converter is driven at the first switching frequency, a load regulation characteristic may be deteriorated, and therefore, a larger voltage drop (e.g., IR-Drop) of the first driving power source VDD may occur. Then, power may be prevented or substantially prevented from exceeding a power specification (e.g., a predetermined power specification) due to an instantaneous increase in a current. This will be described in more detail below.

In an embodiment, when it is determined that the voltage corresponding to the voltage code Vcode is lower than the voltage corresponding to the threshold voltage code, the timing controller 140 may determine (e.g., may set or may adjust) the switching frequency of the DC-to-DC converter as a second frequency (e.g., a second switching frequency). The second switching frequency may be higher than the first frequency. When the DC-to-DC converter is driven at the second switching frequency, the load regulation characteristic may be reinforced, and thus, a desired voltage of the first driving power source VDD may be stably maintained. Accordingly, a stability of the driving may be ensured.

FIG. 2 is a diagram illustrating the pixel shown in FIG. 1 in accordance with an embodiment of the present disclosure. In FIG. 2, the pixel PX located on the ith row and the jth column is illustrated as a representative example. However, the present disclosure is not limited thereto, and the structure of the pixel PX may be variously modified as needed or desired. As an example, in an embodiment of the present disclosure, the pixel PX may have any suitable circuit as would be understood by those having ordinary skill in the art.

Referring to FIG. 2, the pixel PX may be connected to the first scan line SLi, the second scan line SSLi, the data line DLj, and the readout line RLj.

The pixel PX may include a light emitting element LD, a first transistor T1 (e.g., a driving transistor), a second transistor T2, a third transistor T3, and a storage capacitor Cst. Each of the first transistor T1, the second transistor T2, and the third transistor T3 may be a thin film transistor including an oxide semiconductor, but the present disclosure is not limited thereto. For example, at least one (e.g., at least some) of the first transistor T1, the second transistor T2, or the third transistor T3 may include a poly-silicon semiconductor, or may be implemented with an N-type semiconductor or a P-type semiconductor.

A first electrode (e.g., an anode electrode) of the light emitting element LD may be connected to the first power line PL1 via a second node N2 and the first transistor T1, and a second electrode (e.g., a cathode electrode) of the light emitting element LD may be connected to the second power line PL2. The light emitting element LD may emit light having a luminance corresponding to a driving current supplied from the first transistor T1.

The light emitting element LD may be an organic light emitting diode. The light emitting element LD may be an inorganic light emitting diode, such as a micro LED (light emitting diode) or a quantum dot light emitting diode. The light emitting element LD may be an element including (e.g., made of) a combination of an organic material and an inorganic material. In FIG. 2, the pixel PX is illustrated as including a single light emitting element LD. However, in another embodiment, the pixel PX may include a plurality of light emitting elements, and the plurality of light emitting elements may be connected in series, in parallel, or in series/parallel to each other.

A first electrode (e.g., a drain electrode) of the first transistor T1 may be connected to the first power line PL1 to which the first driving power source VDD is applied, and a second electrode (e.g., a source electrode) of the first transistor T1 may be connected to the second node N2. A gate electrode of the first transistor T1 may be connected to a first node N1. The first transistor T1 may control an amount of current flowing through the light emitting element LD corresponding to a voltage of the first node N1 (e.g., a gate-source voltage applied between the gate electrode and the second electrode of the first transistor T1).

A first electrode of the second transistor T2 may be connected to the data line DLj, and a second electrode of the second transistor T2 may be connected to the first node N1. A gate electrode of the second transistor T2 may be connected to the first scan line SLi. When a first scan signal is supplied to the first scan line SLi, the second transistor T2 may be turned on to transfer a data signal VDATA from the data line DLj to the first node N1.

The storage capacitor Cst may be formed or connected between the first node N1 and the second node N2. The storage capacitor Cst may store the voltage of the first node N1.

The third transistor T3 may be connected between the readout line RLj and the second node N2. A gate electrode of the third transistor T3 may be connected to the second scan line SSLi. When a second scan signal is supplied to the second scan line SSLi, the third transistor T3 may be turned on to transfer the voltage of the initialization power source VINT from the readout line RLj to the second node N2.

When the second transistor T2 and the third transistor T3 are concurrently (e.g., simultaneously or substantially simultaneously) turned on with each other in response to the first scan signal and the second scan signal, a voltage difference between the data signal VDATA and the initialization power source VINT may be stored in the storage capacitor Cst. The first transistor T1 may control the amount of current flowing through the light emitting element LD, according to (e.g., corresponding to) the voltage difference stored in the storage capacitor Cst.

As another example, when the third transistor T3 is turned on so that the second node N2 and the readout line RLj are connected to each other during a sensing period, a sensing signal may be provided to the readout line RLj from the pixel PX.

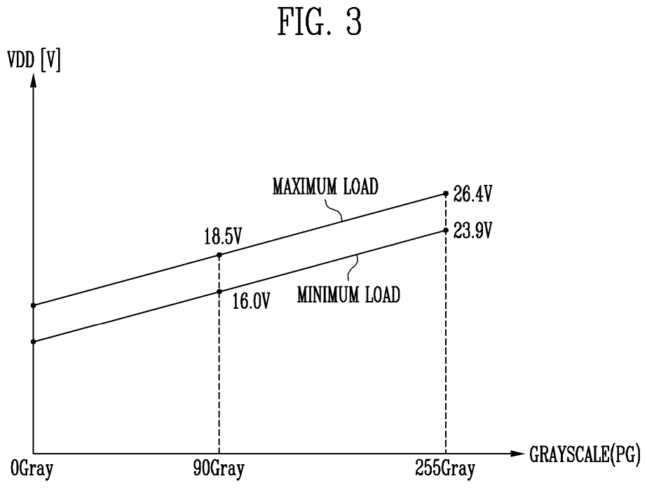

FIG. 3 is a diagram illustrating the first driving power source generated corresponding to a voltage code by the power generator in accordance with an embodiment of the present disclosure. In FIG. 3, the Y axis represents a voltage of the first driving power source VDD, and the X axis represents a peak grayscale (e.g., a peak grayscale value or level) PG. In addition, a minimum load may refer to a minimum load capable of being applied to the display unit 110, and a maximum load may refer to a maximum load capable of being applied to the display unit 110.

Referring to FIG. 3, a voltage of the first driving power source VDD may be determined (e.g., may be set or may be adjusted) corresponding to a load of the display unit 110 and a peak grayscale (e.g., a peak grayscale value or level) PG.

As an example, when the load of the display unit 110 is the minimum load, and the peak grayscale PG is 90 (e.g., 90Gray), the timing controller 140 may supply a voltage code Vcode corresponding to 16.0V to the power generator 150. The power generator 150 may supply the first driving power source VDD having a voltage of 16.0V to the display unit 110.

As an example, when the load of the display unit 110 is the maximum load, and the peak grayscale PG is 90 (e.g., 90Gray), the timing controller 140 may supply a voltage code Vcode corresponding to 18.5V to the power generator 150. The power generator 150 may supply the first driving power source VDD having a voltage of 18.5V to the display unit 110.

As an example, when the load of the display unit 110 is the minimum load or the maximum load, and the peak grayscale PG is 255 (e.g., 255Gray), the timing controller 140 may supply a voltage code Vcode corresponding to 23.9V or 26.4V, respectively, to the power generator 150. The power generator 150 may supply the first driving power source VDD having a voltage of 23.9V or 26.4V to the display unit 110.

In other words, in an embodiment of the present disclosure, the voltage of the first driving power source VDD may be determined (e.g., may be set or adjusted) corresponding to the load of the display unit and the peak grayscale PG, and accordingly, a consumed power of the display device 100 may be reduced.

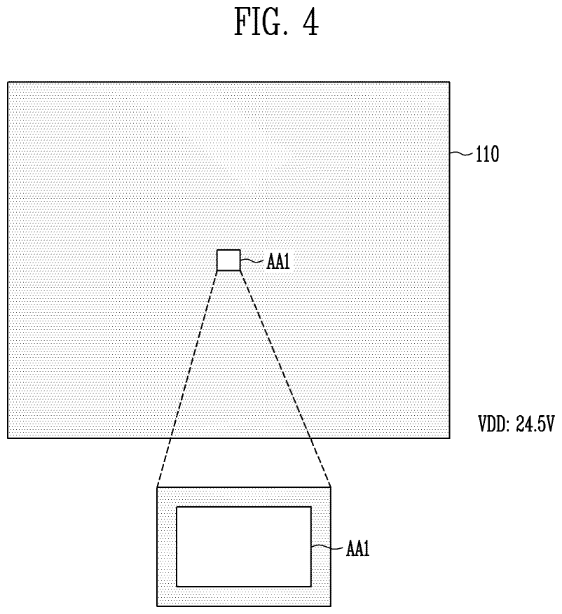

FIG. 4 illustrates an example of a specific pattern that is displayed on the display unit.

FIG. 4 illustrates a case in which most areas of the display unit 110 display a low grayscale (e.g., the grayscale 90), and a partial area AA1 of the display unit 110 displays a high grayscale (e.g., the grayscale 255). The most areas may be (e.g., may be set as) an area corresponding to 99.99% of the display unit 110, and the partial area AA1 may be (e.g., may be set as) an area corresponding to 0.01% the display unit 110.

Referring to FIG. 4, the timing controller 140 may generate a voltage code Vcode corresponding to a load of the display unit 110 and a peak grayscale (e.g., a peak grayscale value or level) PG. When the peak grayscale PG has a high value even though the most areas of the display unit 110 display a low grayscale, the timing controller 140 may generate the voltage code Vcode so that the first driving power source VDD having a high voltage is generated in the power generator 150. As an example, when a high grayscale is displayed in the partial area AA1, a voltage of the first driving power source VDD may be determined (e.g., may be set or may be adjusted) to 24.5V, which is lower by 1.9V than a highest voltage (e.g., 26.4V) capable of being supplied to the display unit 110.

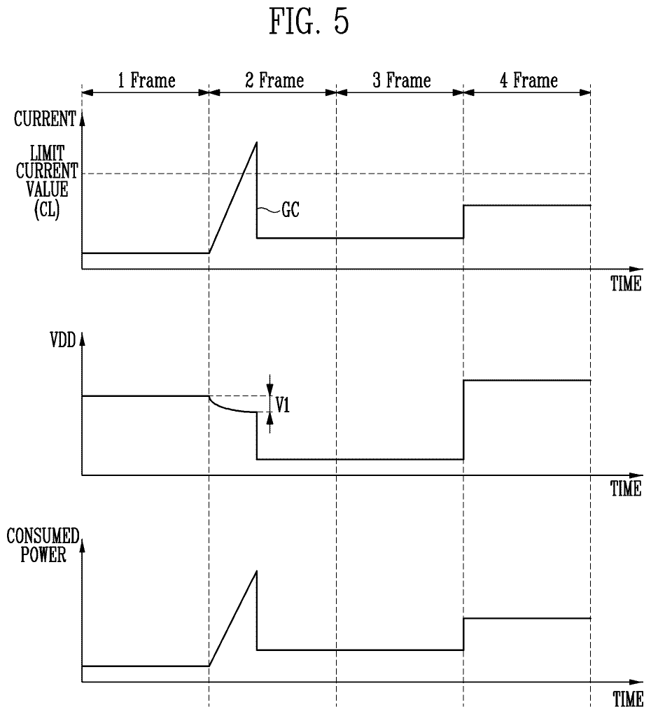

FIG. 5 is a diagram illustrating a driving current and a consumed power when the DC-to-DC converter included in the power generator is driven at a high driving frequency. For example, the voltage of the first driving power source VDD may be delayed by one frame to be reflected.

Referring to FIG. 5, during a first frame period (1 Frame) and a previous frame period, a high grayscale may be displayed in the partial area AA1 of the display unit 110, and a low grayscale may be displayed in the other areas of the display unit 110 as shown in FIG. 4. In this case, the first driving power source VDD may have a relatively high voltage.

During a second frame period (2 Frame), an image with a high grayscale (e.g., a white grayscale (255)) may be displayed in all the areas of the display unit 110. A global current value GC may be sharply increased corresponding to a sharp increase in a load of the display unit 110. As an example, during the second frame period (2 Frame), the global current value GC may exceed a limit current value CL. The limit current value CL may be a current value (e.g., a predetermined current value), and may refer to a limit value with which the display device 100 may be normally driven.

During the second frame period (2 Frame), a consumed power of the display device 100 may be rapidly increased corresponding to the increase in the global current value GC. As an example, during the second frame period (2 Frame), the consumed power of the display device 100 may exceed a power specification. When the consumed power of the display device 100 exceeds the power specification, a probability that the display device 100 will be damaged may be increased. Also, when the consumed power of the display device 100 exceeds the power specification, the display device 100 may be determined to be defective, and therefore, manufacturing costs may be increased.

Because the first driving power source VDD may be delayed by one frame to be reflected, the first driving power source VDD may have a voltage corresponding to an image of the first frame period (1 Frame) during the second frame period (2 Frame).

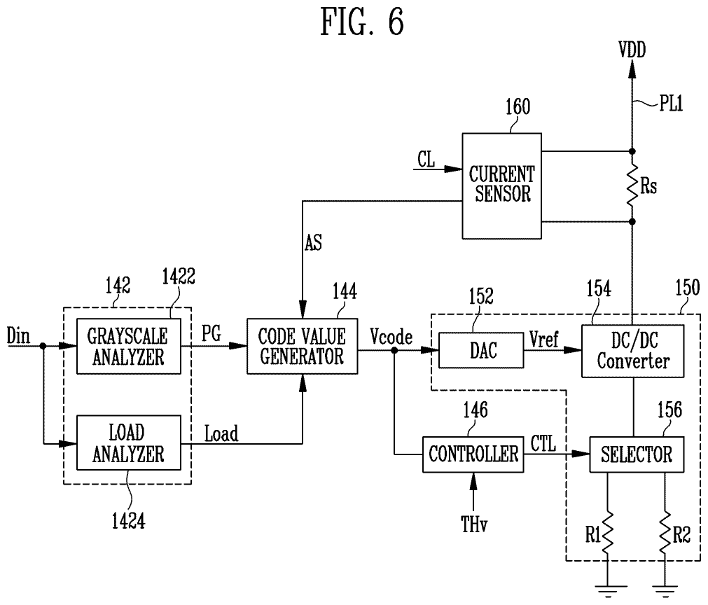

When a DC-to-DC converter 154 (e.g., see FIG. 6) included in the power generator 150 is driven at a relatively high switching frequency (e.g., the second switching frequency), the voltage of the first driving power source VDD may maintain or substantially maintain a relatively stable voltage even through the load of the display unit 110 is sharply increased. As an example, when the DC-to-DC converter 154 is driven at the second switching frequency, the voltage of the first driving power source VDD may be decreased by a relatively low first voltage V1.

When the global current value GC has (e.g., is set to) the limit current value CL or higher, the current sensor 160 may supply the alarm signal AS to the timing controller 140. The timing controller 140 supplied with the alarm signal AS may generate a voltage code Vcode so that the voltage of the first driving power source VDD is decreased. Thus, during a second half of the second frame period (2 Frame), the voltage of the first driving power source VDD may be decreased, and accordingly, the global current value GC and the consumed power may be reduced.

The timing controller 140 may maintain or substantially maintain a voltage of the first driving power source VDD, which is decreased during at least one frame (e.g., a third frame period (3 Frame)). Also, the timing controller 140 may normally set a voltage of the first driving power source VDD during a subsequent frame period (e.g., a fourth frame period (4 Frame)).

FIG. 6 is a diagram illustrating a timing controller and a power generator in accordance with an embodiment of the present disclosure.

Referring to FIG. 6, the timing controller 140 in accordance with an embodiment of the present disclosure may include an analyzer 142, a code value generator 144, and a controller 146. In addition, various other components may be included in the timing controller 140. However, for convenience of illustration, the components illustrated in FIG. 6 will be described in more detail hereinafter.

The analyzer 142 may calculate (e.g., may analyze) a load Load of input data Din, or may extract a peak grayscale (e.g., a Max grayscale) PG. As such, the analyzer 142 may include a grayscale analyzer 1422 and a load analyzer 1424.

The grayscale analyzer 1422 may extract a peak grayscale (e.g., a peak grayscale value or level) PG from the input data Din of one frame. The peak grayscale PG may refer to a highest grayscale (e.g., a highest grayscale value or level) among the input data Din included in the one frame.

The load analyzer 1424 may calculate a load Load of the input data Din corresponding to one frame. As an example, the load analyzer 1424 may calculate the load Load by averaging the grayscales of the input data Din of the one frame. Various suitable methods as would be understood by those having ordinary skill in the art may be used, by the load analyzer 1424, to calculate the load Load.

The code value generator 144 may generate a voltage code Vcode corresponding to the peak grayscale PG and the load Load. The voltage code Vcode may include voltage information corresponding to the peak grayscale PG and the load Load. The voltage code Vcode generated by the code value generator 144 may be supplied to the controller 146 and a power generator 150.

Additionally, when the alarm signal AS is input from the current sensor 140, the code value generator 144 may generate a voltage code Vcode so that the first driving power source VDD has a low voltage. As an example, when the alarm signal AS is input, the code value generator 144 may generate the voltage code Vcode corresponding to a lowest voltage capable of being generated by the power generator 150 (e.g., a lowest voltage of the first driving power source VDD).

The controller 146 may compare a threshold voltage code (e.g., a predetermined threshold voltage code) THv with the voltage code Vcode, and generate a control signal CTL based on a comparison result. The threshold voltage code THv may correspond to any one of voltage values of 80% or more when a highest voltage value of the first driving power source VDD is set to 100%.

In an embodiment, when it is determined that the voltage code Vcode (e.g., a voltage of the voltage code Vcode) is the threshold voltage code THv (e.g., a threshold voltage) or higher, the controller 146 may supply the control signal CTL having a first level to the power generator 150.

In an embodiment, when it is determined that the voltage code Vcode (e.g., the voltage of the voltage code Vcode) is lower than the threshold voltage code THv (e.g., the threshold voltage), the controller 146 may supply the second level control signal CTL to the power generator 150. The first level may be determined (e.g., may be set or may be adjusted) to a logic high voltage (or a logic low voltage), and the second level may be determined (e.g., may be set or may be adjusted) to a logic low voltage (or a logic high voltage).

The power generator 150 in accordance with an embodiment of the present disclosure may include a digital-to-analog converter (DAC) 152, a DC-to-DC converter 154, a selector 156, a first resistor R1, and a second resistor R2.

The DAC 152 may generate a reference voltage Vref corresponding to the voltage code Vcode, and may supply the reference voltage Vref to the DC-to-DC converter 154. As an example, the DAC 152 may supply the reference voltage Vref between 0V to 3.3V (or a maximum of 4.8V) to the DC-to-DC converter 154.

The DC-to-DC converter 154 may generate the first driving power source VDD having a suitable voltage (e.g., a predetermined voltage) based on the reference voltage Vref, and may supply the first driving power source VDD to the first power line PL1. The voltage of the first driving power source VDD generated by the DC-to-DC converter 154 may be determined based on the reference voltage Vref (e.g., the voltage code Vcode).

The selector 156 may electrically connect the first resistor R1 or the second resistor R2 to the DC-to-DC converter 154, corresponding to (e.g., according to) a first level control signal CTL or a second level control signal CTL. As an example, the selector 156 may connect the first resistor R1 to the DC-to-DC converter 154 corresponding to the first level control signal CTL. As an example, the selector 156 may connect the second resistor R2 to the DC-to-DC converter 154 corresponding to the second level control signal CTL. For example, in some embodiments, the selector 156 may include a switch. The first resistor R1 may have a higher resistance value as compared with that of the second resistor R2.

The DC-to-DC converter 154 may change a switching frequency corresponding to the first resistor R1 or the second resistor R2, which is electrically connect thereto. In an embodiment, when the selector 156 is connected to the first resistor R1, the DC-to-DC converter 154 may be driven at a first switching frequency. A load regulation characteristic of the DC-to-DC converter 154 may be deteriorated, and therefore, a larger voltage drop (e.g., an IR-Drop) of the first driving power source VDD may occur.

In other words, in an embodiment of the present disclosure, when the voltage of the first driving power source VDD is high (e.g., when it is determined that the voltage of the first driving power source VDD is the threshold voltage code THv (e.g., the threshold voltage) or higher), the DC-to-DC converter 154 may be driven at the first switching frequency, and accordingly, a voltage drop width of the first driving power source VDD may be increased when the load of the display unit is sharply increased. Thus, an increase in a consumed power (e.g., an exceeding of the power specification), corresponding to a sharp increase in a global current value GC, may be prevented or substantially prevented.

In an embodiment, when the selector 156 is connected to the second resistor R2, the DC-to-DC converter 154 may be driven at the second switching frequency. Thus, the load regulation characteristic of the DC-to-DC converter 154 may be reinforced, and accordingly, the voltage drop (e.g., the IR-Drop) of the first driving power source VDD may be minimized or reduced.

In other words, in an embodiment of the present disclosure, when the voltage of the first driving power source VDD is lower than the voltage of the threshold voltage code THv, the DC-to-DC converter 154 may be driven at the second switching frequency, and accordingly, the voltage of the first driving power source VDD may be stably maintained.

The DC-to-DC converter 154 may be implemented with various suitable circuits as would be understood by those having ordinary skill in the art. As an example, the DC-to-DC converter 154 may be implemented with ISL81802 by RENESAS Electronics Corp., which is a commercial integrated circuit (IC). In the case of ISL81802, a fundamental switching frequency may be changed to 100 Hz to 1 MHz corresponding to the resistor connected to the DC-to-DC converter 154.

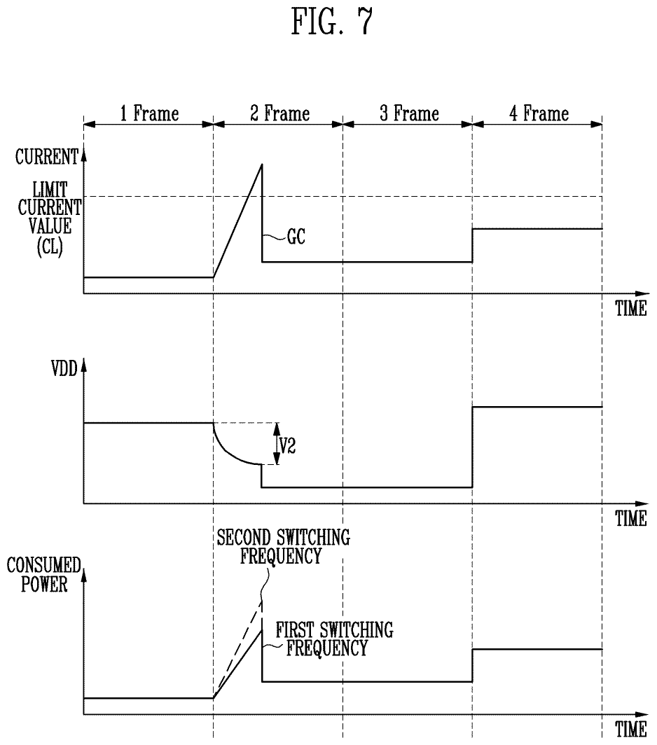

FIG. 7 is a diagram illustrating a driving current and a consumed power when the DC-to-DC converter is driven at the first switching frequency.

Referring to FIG. 7, during a first frame period (1 Frame) and a previous frame period, a high grayscale (e.g., a high grayscale value or level) may be displayed in the partial area AA1 of the display unit 110, and a low grayscale (e.g., a low grayscale value or level) may be displayed in the other areas of the display unit 110, as shown in FIG. 4.

During the first frame period (1 Frame), the controller 146 may compare the threshold voltage code THv with the voltage code Vcode, and may generate the first level control signal CTL based on a comparison result. The selector 156 may connect the first resistor R1 to the DC-to-DC converter 154 corresponding to the first level control signal CTL. The DC-to-DC converter 154 connected to the first resistor R1 may be driven at the first switching frequency.

During a second frame period (2 Frame), an image with a high grayscale (e.g., a white grayscale (255)) may be displayed in all of the areas of the display unit 110. A current flowing through the display unit 110 (e.g., a global current value GC) may be sharply increased. As an example, during the second frame period (2 Frame), the global current value GC may exceed a limit current value CL. The limit current value CL may be a suitable current value (e.g., a predetermined current value), and may refer to a limit value with which the display device 100 may be normally driven.

Because the DC-to-DC converter 154 may be driven at the first switching frequency during the second frame period (2 Frame), the voltage of the first driving power source VDD may be decreased by a second voltage V2 corresponding to a sharp increase in the load of the display unit 110. The second voltage V2 may be a voltage higher than that of the first voltage V1 shown in FIG. 5.

During the second frame period (2 Frame), a consumed power of the display device 100 may be rapidly increased corresponding to the increase in the global current value GC. However, the voltage of the first driving power source VDD may be decreased by the second voltage V2, and the consumed power may be reduced by the second voltage V2. During the second frame period (2 Frame), the consumed power of the display device 100 may not exceed the power specification.

As an example, in FIG. 7, a portion indicated by a dotted line in relation to the consumed power may represent the consumed power when the DC-to-DC converter 154 is driven at the second switching frequency, and a portion indicated by a solid line in relation to the consumed power may represent the consumed power when the DC-to-DC converter 154 is driven at the first switching frequency.

In an embodiment of the present disclosure, when the first driving power source has (e.g., is set to) a voltage higher than the threshold voltage, the DC-to-DC converter 154 may be driven at the first switching frequency, and accordingly, a rapid increase in a consumed power may be prevented or substantially prevented, even though the load of the display unit 110 is sharply increased.

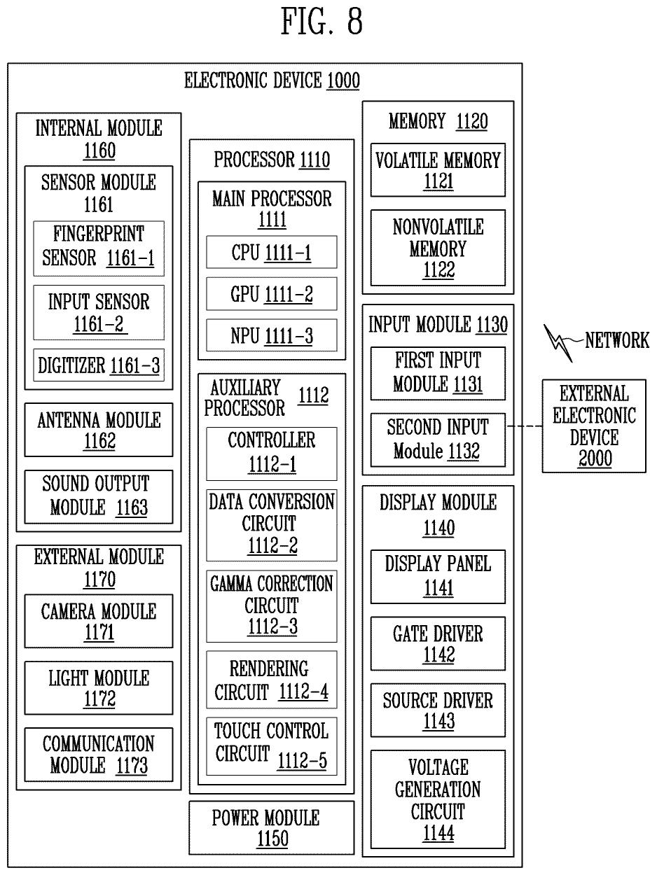

FIG. 8 is a diagram illustrating an electronic device in accordance with an embodiment of the present disclosure.

Referring to FIG. 8, an electronic device 1000 in accordance with an embodiment of the present disclosure may output various suitable information through a display module 1140. When a processor 1110 executes an application stored in a memory 1120, the display module 1140 may provide application information to a user through a display panel 1141.

The processor 1110 may acquire an external input through an input module 1130 or a sensor module 1161, and may execute an application corresponding to the external input. For example, when the user selects a camera icon (e.g., a camera application icon) displayed on the display panel 1141, the processor 1110 may acquire a user input through an input sensor 1161-2, and may activate a camera module 1171. The processor 1110 may transfer, to the display module 1140, image data corresponding to a photographed image acquired through the camera module 1171. The display module 1140 may display an image corresponding to the photographed image through the display panel 1141.

As another example, when personal information authentication is executed in the display module 1140, a fingerprint sensor 1161-1 may acquire input fingerprint information as input data. The processor 1110 may compare the input data acquired through the fingerprint sensor 1161-1 with authentication data stored in the memory 1120, and may execute an application according to a comparison result. The display module 1140 may display information executed according to a logic of the application through the display panel 1141. The fingerprint sensor 1161-1 may be disposed to acquire fingerprint information in the entire area of the display panel 1141.

As another example, when a music streaming icon displayed on the display module 1140 is selected, the processor 1110 may acquire a user input through the input sensor 1161-2, and may active a music streaming application stored in the memory 1120. When a music play command is input in the music streaming application, the processor 1110 may activate a sound output module 1163, thereby providing the user with sound information that accords with the music play command.

In the above, operations of the electronic device 1000 have been briefly described. Hereinafter, components of the electronic device 1000 will be described in more detail. Some of the components of the electronic device 1000, which will be described in more detail below, may be integrated with each other to be provided as one component, and/or one component may be separated into two or more components.

The electronic device 1000 may communicate with an external electronic device 2000 through a network (e.g., a short-range wireless communication network or a long-range wireless communication network). In accordance with an embodiment, the electronic device 1000 may include the processor 1110, the memory 1120, the input module 1130, the display module 1140, a power module 1150, an internal module 1160, and an external module 1170. In accordance with an embodiment, in the electronic device 1000, at least one of the above-described components may be omitted as needed or desired, or one or more other components may be added. In accordance with an embodiment, some components (e.g., the sensor module 1161, an antenna module 1162, and/or the sound output module 1163) among the above-described components may be integrated into another component (e.g., the display module 1140).

The processor 1110 may control at least another component (e.g., a hardware or software component) of the electronic device 1000, which is connected to the processor 1110, by executing software, and may perform various processing or calculations. In accordance with an embodiment, as at least a portion of the data processing and calculations, the processor 1110 may store, in a volatile memory 1121, a command or data, received from another component (e.g., the input module 1130, the sensor module 1161, or a communication module 1173), process the command or data, stored in the volatile memory 1121, and store result data in a nonvolatile memory 1122.

The processor 1110 may include a main processor 1111 and an auxiliary processor 1112. The main processor 1111 may include a central processing unit (CPU) 1111-1. The main processor 1111 may further include at least one of a graphic processing unit (GPU) 1111-2, a communication processor (CP), or an image signal processor (ISP). The main processor 1111 may further include a neural processing unit (NPU) 1111-3. The NPU 1111-3 is a processor specified for processing an artificial intelligence (AI) model, and the AI model may be generated through machine learning. The AI model may include a plurality of artificial neural network layers. An artificial neural network may be a deep neural network (DNN), a convolutional neural network (CNN), a recurrent neural network (RNN), a restricted boltzman machine (RBM), a deep belief network (DBN), a bidirectional recurrent deep neural network (BRDNN), a deep Q-networks, or one of two or more combinations thereof, but the present disclosure is not limited thereto. The AI model may additionally or alternatively include a software structure, in addition to a hardware structure. At least two of the above-described processing units and the above-described processors may be implemented into one integrated component (e.g., a single chip), or be implemented as components (e.g., a plurality of chips) independent from each other.

The auxiliary processor 1112 may include a controller 1112-1. The controller 1112-1 may include an interface conversion circuit and a timing control circuit. As an example, the controller 1112-1 may include the timing controller 140 shown in FIG. 1. As an example, the controller 1112-1 may include the analyzer 142, the code value generator 144, and the controller 146, which are shown in FIG. 6. The controller 1112-1 may receive an image signal from the main processor 1111, and may convert a data format of the image signal to be suitable for interface specifications with the display module 1140, thereby outputting image data. The controller 1112-1 may output various control signals used for driving of the display module 1140.

The auxiliary processor 1112 may further include a data conversion circuit 1112-2, a gamma correction circuit 1112-3, a rendering circuit 1112-4, a touch control circuit 1112-5, and the like. The data conversion circuit 1112-2 may receive image data from the controller 1112-1, and may compensate for the image data so that an image is displayed with a desired luminance according to a characteristic of the electronic device 1000 or a setting of the user, or may convert the image data for the purpose of reduction of a power consumption, afterimage compensation, or the like.

The gamma correction circuit 1112-3 may convert image data, a gamma reference voltage, or the like, such that an image displayed in the electronic device 1000 has a desired gamma characteristic. The rendering circuit 1112-4 may receive image data from the controller 1112-1, and may render the image data by considering a pixel arrangement of the display panel 1141 and the like.

The touch control circuit 1112-5 may supply a touch signal to the input sensor 1161-2, and may be supplied with a sensing signal from the input sensor 1161-2 corresponding to the touch signal.

At least one of the data conversion circuit 1112-2, the gamma correction circuit 1112-3, the rendering circuit 1112-4, or the touch control circuit 1112-5 may be integrated into another component (e.g., the main processor 1111 or the controller 1112-4). At least one of the data conversion circuit 1112-2, the gamma correction circuit 1112-3, or the rendering circuit 1112-4 may be integrated into a source driver 1143, which will be described in more detail below.

The memory 1120 may store various data used by at least one component (e.g., the processor 1110 or the sensor module 1161) of the electronic device 1000, and may input or output data about a command associated therewith. Also, various setting data corresponding to the settings of the user may be stored in the memory 1120. The memory 1120 may include at least one of the volatile memory 1121 or the nonvolatile memory 1122.

The input module 1130 may receive a command or data to be used in a component (e.g., the processor 1110, the sensor module 1161, or the sound output module 1163) of the electronic device 1000 from the outside (e.g., the user or the external electronic device 2000) of the electronic device 1000.

The input module 1130 may include a first input module 1131 to which a command or data is input from the user, and a second input module 1132 to which a command or data is input from the external electronic device 2000. The first input module 1131 may include a microphone, a mouse, a keyboard, a key (e.g., a button), or a pen (e.g., a passive pen or an active pen). The second input module 1132 may support a specified protocol capable of connecting the electronic device 1000 to the external electronic device 2000 by wired or wireless connections. In accordance with an embodiment, the second input module 1132 may include a high definition multimedia interface (HDMI), a universal serial bus (USB) interface, an SD card interface, or an audio interface. The second input module 1132 may include a connector, e.g., an HDMI connector, a USB connector, an SD card connector, or an audio connector (e.g., a headphone connector), which can physically connect the electronic device 1000 to the external electronic device 2000.

The display module 1140 may visually provide information to the user. The display module 1140 may include the display panel 1141, a gate driver 1142, the source driver 1143, and a voltage generating circuit 1144. The display module 1140 may further include a window for protecting the display panel 1141, a chassis, and a bracket. The display module 1140 may include at least some components of the display device 100 shown in FIG. 1.

The display panel 1141 (e.g., a display) may include a liquid crystal display panel, an organic light emitting display panel, or an inorganic light emitting display panel, but the kind of the display panel 1141 is not particularly limited thereto. The display panel 1141 may be of a rigid kind, or a flexible kind in which the display panel 1141 is rollable or foldable. The display module 1140 may further include a supporter for supporting the display panel 1141, a bracket, a heat dissipation member, or the like. The display panel 1141 may include the display unit 110 shown in FIG. 1.

The gate driver 1142 may be a driving chip, and may be mounted in the display panel 1141. As another example, the gate driver 1142 may be integrated in the display panel 1141. For example, the gate driver 1142 may include an Amorphous Silicon TFT Gate (ASG) driver circuit, a Low Temperature Polycrystalline Silicon (LTPS) TFT gate driver circuit, or an Oxide Semiconductor TFT Gate (OSG) driver circuit, which may be embedded in the display panel 1141. The gate driver 1142 may receive a control signal from the controller 1112-1, and may output scan signals to the display panel 1141 in response to the control signal. The gate driver 1142 may include the scan driver 120 shown in FIG. 1.

The display module 1140 may further include an emission driver. The emission driver may output an emission control signal to the display panel 1141 in response to a control signal received from the controller 1112-1. The emission driver may be formed separately from the gate driver 1142, or may be integrated in the gate driver 1142.

The source driver 1143 may receive a control signal from the controller 1112-1, and may convert image data into an analog voltage (e.g., a data voltage) and output data voltages to the display panel 1141 in response to the control signal. The source driver 1143 may include the data driver 130 shown in FIG. 1.

The source driver 1143 may be integrated in another component (e.g., the controller 1112-1). Functions of the interface conversion circuit and the timing control circuit of the controller 1112-1, which are described above, may be integrated in the source driver 1143. Additionally, the display module 1140 may further include a current sensor 160 shown in FIG. 1.

The voltage generating circuit 1144 may output various voltages used for driving of the display panel 1141. As an example, the voltage generating circuit 1144 may include the power generator 150 shown in FIG. 1. The voltage generating circuit 144 may include the digital-to-analog converter (DCA) 152, the DC-to-DC converter 154, and the selector 156, which are shown in FIG. 6. In an embodiment, the display panel 1141 may include the pixels PX shown in FIG. 1.

In an embodiment, the source driver 1143 may convert data corresponding to red (R), green (G), and blue (B), which may be included in image data received from the processor 1110, into a red data signal (e.g., a data voltage), a green data signal, and a blue data signal, and may provide the red data signal, the green data signal, and the blue data signal to a plurality of pixel columns included in the display panel 1141 during one horizontal period.

The power module 1150 may supply power to at least one component of the electronic device 1000. The power module 1150 may include a battery for charging a power voltage. The battery may include a primary cell that is not rechargeable, a secondary cell that is rechargeable, or a fuel cell. The power module 1150 may include a power management integrated circuit (PMIC). The PMIC may supply an optimized power source to each of the above-described modules and the modules described in more detail below. The power module 1150 may include a wireless power transmission/reception member electrically connected to the battery. The wireless power transmission/reception member may include a plurality of coil-shaped antenna radiators. In an embodiment, at least some components of the power module 1150 and the voltage generating circuit 1144 may be provided to be integrated into one. The voltage generating circuit 1144 may be included in the power module 1150.

The electronic device 1000 may further include the internal module 1160 and the external module 1170. The internal module 1160 may include the sensor module 1161, the antenna module 1162, and the sound output module 1163. The external module 1170 may include the camera module 1171, a light module 1172, and the communication module 1173.

The sensor module 1161 may sense an input caused by a body of the user or an input caused by a pen in the first input module, and generate an electrical signal or a data value, which corresponds to the input. The sensor module 1161 may include at least one of the fingerprint sensor 1161-1, the input sensor 1161-2, and a digitizer 1161-3.

The fingerprint sensor 1161-1 may generate a data value corresponding to a fingerprint of the user.

The input sensor 1161-2 may generate a data value corresponding to coordinate information of the input caused by the body of the user or the input caused by the pen. The input sensor 1161-2 may generate, as a data value, a capacitance variation caused by the input. The input sensor 1161-2 may sense an input caused by a passive pen, or may transmit/receive data to/from an active pen.

The input sensor 1161-2 may measure a biometric signal, such as pressure, moisture, or body fat. For example, when the user does not move for a constant time while a body part of the user is in contact with a sensor layer or a sensing panel, the input sensor 1161-2 may output information that the user wants to the display module 1140 by sensing a biometric signal based on a change in an electric field caused by the body part.

The digitizer 1161-3 may generate a data value corresponding to the coordinate information of the input caused by the pen. The digitizer 1161-3 may generate, as a data value, an electromagnetic variation caused by the input. The digitizer 1161-3 may sense an input caused by the passive pen, or may transmit/receive data to/from the active pen.

At least one of the fingerprint sensor 1161-1, the input sensor 1161-2, or the digitizer 1161-3 may be implemented as a sensor layer formed on the display panel 1141 through a continuous process. At least one of the fingerprint sensor 1161-1, the input sensor 1161-2, or the digitizer 1161-3 may be disposed at an upper side of the display panel 1141, and any one, e.g., the digitizer 1161-3, among the fingerprint sensor 1161-1, the input sensor 1161-2, and the digitizer 1161-3 may be disposed at a lower side of the display panel 1141.

At least two of the fingerprint sensor 1161-1, the input sensor 1161-2, or the digitizer 1161-3 may be formed to be integrated into one sensing panel through the same process. When at least two of the fingerprint sensor 1161-1, the input sensor 1161-2, or the digitizer 1161-3 are integrated into one sensing panel, the sensing panel may be disposed between the display panel 1141 and the window disposed at an upper side of the display panel 1141. In accordance with an embodiment, the sensing panel may be disposed on the window, but the position of the sensing panel is not particularly limited thereto.

At least one of the fingerprint sensor 1161-1, the input sensor 1161-2, or the digitizer 1161-3 may be built in the display panel 1141. In other words, at least one of the fingerprint sensor 1161-1, the input sensor 1161-2, or the digitizer 1161-3 may be concurrently (e.g., simultaneously or substantially simultaneously) formed through a process of forming elements (e.g., a light emitting element, a transistor, and the like) included in the display panel 1141.

The sensor module 1161 may generate an electrical signal or a data value, which corresponds to an internal state or an external state of the electronic device 1000. The sensor module 1161 may further include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 1162 may include one or more antennas for transmitting a signal or power to the outside, or receiving a signal or power from the outside. In accordance with an embodiment, the communication module 1173 may transmit a signal to the external electronic device, or may receive a signal from the external electronic device through an antenna suitable for a communication scheme. An antenna pattern of the antenna module 1162 may be integrated in one component (e.g., the display panel 1141) of the display module 1140, the input sensor 1161-2, or the like.

The sound output module 1163 may be a device for outputting a sound signal to the outside of the electronic device 1000, and may include, for example, a speaker used for a general purpose, such as multimedia playback or transcription playback, and a receiver used for a call reception. In accordance with an embodiment, the receiver may be integrally formed with the speaker, or may be formed separately from the speaker. A sound output pattern of the sound output module 1163 may be integrated in the display module 1140.

The camera module 1171 may photograph a still image and/or a moving image. In accordance with an embodiment, the camera module 1171 may include one or more lenses, an image sensor, or an image signal processor. The camera module 1171 may further include an infrared camera capable of measuring an existence of the user, a position of the user, eyes of the user, or the like.

The light module 1172 may provide light. The light module 1172 may include a light emitting diode or a xenon lamp. The light module 1172 may operate in a linkage with the camera module 1171, or may operate independently from the camera module 1171.

The communication module 1173 may establish a wired or wireless communication channel between the electronic device 1000 and the external electronic device 2000, and may support communication performance through the established communication channel. The communication module may include any one or all of a wireless communication module, such as a cellular communication module, a short-range wireless communication module, or a global navigation satellite system (GNSS) communication module, and a wired communication module, such as a local area network (LAN) communication module or a power line communication (PLC) module. The communication module 1173 may communicate with the external electronic device 2000 through a short-range communication network, such as Bluetooth™, wireless-fidelity (WiFi) direct, or infrared data association (IrDA), or a long-range communication network, such as a cellular network, Internet, or a computer network (e.g., LAN or wide area network (WAN)). The above-described communication modules may be implemented into one chip, or may be respectively implemented as separate chips.

The input module 1130, the sensor module 1161, the camera module 1171, and the like may be used to control an operation of the display module 1140 in a linkage with the processor 1110.

The processor 1110 may output a command or data to the display module 1140, the sound output module 1163, the camera module 1171, or the light module 1172, based on input data received from the input module 1130. For example, the processor 1110 may generate image data corresponding to input data applied through a mouse, an active pen, or the like, and may output the image data to the display module 1140. As another example, the processor 1110 may generate command data corresponding to the input data, and may output the command data to the camera module 1171 or the light module 1172. When no input data is received from the input module 1130, the processor 1110 may change the operation mode of the electronic device 1000 to a low power mode or a sleep mode, thereby reducing a power consumed in the electronic device 1000.

The processor 1110 may output a command or data to the display module 1140, the sound output module 1163, the camera module 1171, or the light module 1172, based on sensing data received from the sensor module 1161. For example, the processor 1110 may compare authentication data applied by the fingerprint sensor 1161-1 with authentication data stored in the memory 1120, and then may execute an application according to a comparison result. The processor 1110 may execute a command or may output corresponding image data to the display module 1140, based on sensing data sensed by the input sensor 1161-2 or the digitizer 1161-3. When a temperature sensor is included in the sensor module 1161, the processor 1110 may receive temperature data about a temperature measured from the sensor module 1161, and may further perform a luminance correction on image data based on the temperature data.

The processor 1110 may receive measurement data about an existence of the user, a position of the user, eyes of the user, or the like from the camera module 1171. The processor 1110 may further perform a luminance correction on the image data based on the measurement data. For example, the process 1110 decides the existence of the user through an input from the camera module 1171, and may output image data of which the luminance thereof is corrected to the display module 1140 through the data conversion circuit 1112-2 or the gamma correction circuit 1112-3.

At least some of the above-described components may be connected to each other and may communicate signals (e.g., commands or data) therebetween through an inter-peripheral communication scheme, e.g., a bus, a general purpose input/output (GPIO), a serial peripheral interface (SPI), a mobile industry processor interface (MIPI), or an ultra path interconnect (UPI) link. The processor 1110 may communicate with the display module 1140 through an appointed interface, and may use any one of the above-described communication schemes. However, the present disclosure is not limited thereto.

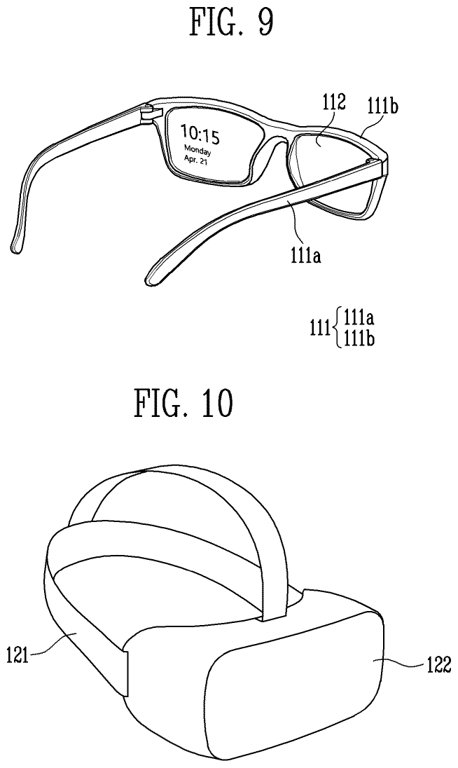

FIGS. 9 through 12 are views illustrating electronic devices in accordance with various embodiments of the present disclosure.

Referring to FIG. 9, the display device 100 in accordance with an embodiment of the present disclosure may be applied to smart glasses. The smart glasses include a frame 111 and a lens part 112. The smart glasses may be a wearable electronic device that can be worn on the face of a user, and may have a structure in which a portion of the frame 111 may be folded or unfolded. For example, the smart glasses may be a wearable device for Augmented Reality (AR).

The frame 111 may include a housing 111b for supporting the lens part 112, and a leg part 111a for allowing the user to wear the smart glasses. The leg part 111a may be connected to the housing 111 by a hinge to be folded or unfolded.

A battery, a touch pad, a microphone, and/or a camera may be built in the frame 111. In addition, a projector for outputting light and/or a processor for controlling a light signal may be built in the frame 111.

The lens part 112 may be an optical member that allows light to be transmitted therethrough, or allows light to be reflected thereby. The lens part 112 may include glass and/or a transparent synthetic resin.

The display device 100 in accordance with an embodiment of the present disclosure may be applied to the lens part 112. As an example, the user may recognize an image displayed by a light signal transmitted from the projector of the frame 111 through the lens part 112. For example, the user may recognize information including time, data, and the like, which are displayed on the lens part 112.

Referring to FIG. 10, the display device 100 in accordance with an embodiment of the present disclosure may be applied to a Head Mounted Display (HMD). The HMD may include a head mounted band 121 and a display accommodating case 122. For example, the HMD may be a wearable electronic device that can be worn on the head of a user.

The head mounted band 121 may be connected to the display accommodating case 122 to fix the display accommodating case 122. The head mounted band 121 may include a horizontal band and a vertical band to fix the HMD to the head of the user. The horizontal band may be provided to surround (e.g., around a periphery of) a side portion of the head of the user, and the vertical band may be provided to surround (e.g., around a periphery of) a top portion of the head of the user. However, the present disclosure is not necessarily limited thereto, and the head mounted band 121 may be implemented in the shape of a glasses frame or a helmet.

The display accommodating case 122 accommodates the display device, and may include at least one lens. The at least one lens may provide an image to the user. For example, the display device 100 in accordance with an embodiment of the present disclosure may be applied to a left-eye lens and a right-eye lens, which are implemented in the display accommodating case 122.

Referring to FIG. 11, the display device 100 in accordance with an embodiment of the present disclosure may be applied to a smart watch. The smart watch may include a display part 131 and a strap part 133. The smart watch may be a wearable electronic device, and may be mounted on a wrist of a user. The display device 100 in accordance with an embodiment of the present disclosure may be applied to the display part 131. For example, the display part 131 may provide image data including information, such as time and date.

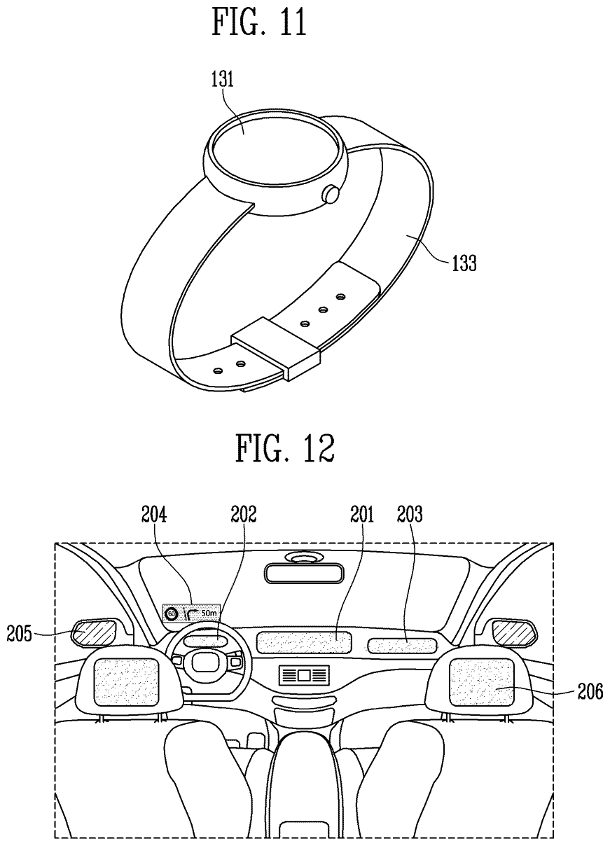

Referring to FIG. 12, the display device 100 in accordance with an embodiment of the present disclosure may be applied to an automotive display. As an example, the automotive display may refer to an electronic device provided at the inside/outside of a vehicle to provide image data.

For example, the display device 100 in accordance with an embodiment of the present disclosure may be applied to at least one of an infortainment panel 201, a cluster 202, a co-driver display 203, a head-up display 204, a side mirror display 205, or a rear seat display 206, which are provided in the vehicle.

In the display device, the method of driving the display device, and the electronic device in accordance with some embodiments of the present disclosure, a switching frequency of the DC-to-DC converter that generates a first driving power source may be differently determined (e.g., differently set or adjusted) corresponding to (e.g., according to) a voltage of the first driving power source. Thus, a sharp increase in a consumed power may be prevented or substantially prevented, even though a load of the display unit may be sharply increased, and accordingly, the stability of the driving may be ensured.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A display device comprising:
a display unit comprising pixels connected to a first power line, a second power line, scan lines, and data lines;
a sensing resistor between the first power line and the display unit, or between the second power line and the display unit;
a current sensor configured to measure a global current value flowing through the sensing resistor;
a timing controller configured to generate a voltage code based on input data; and
a power generator comprising a DC-to-DC converter configured to generate a first driving power source to be supplied to the first power line, based on the voltage code,
wherein the timing controller is further configured to compare the voltage code with a threshold voltage code, and
wherein the power generator is configured to control a switching frequency of the DC-to-DC converter based on a comparison result of the voltage code and the threshold voltage code.

2. The display device of claim 1, wherein the power generator is configured to drive the DC-to-DC converter at a first switching frequency when the voltage code is the threshold voltage code or higher, and
wherein the power generator is configured to drive the DC-to-DC converter at a second switching frequency different from the first switching frequency when the voltage code is lower than the threshold voltage code.

3. The display device of claim 2, wherein the second switching frequency is higher than the first switching frequency.

4. The display device of claim 1, wherein the threshold voltage code corresponds to a voltage value of 80% or more when a highest voltage value of the first driving power source supplied from the power generator is 100%.

5. The display device of claim 1, wherein the timing controller comprises:
an analyzer configured to extract a load of the input data and a peak grayscale;
a code value generator configured to generate the voltage code corresponding to the load and the peak grayscale; and
a controller configured to compare the voltage code with the threshold voltage code, and generate a control signal based on the comparison result.

6. The display device of claim 5, wherein the analyzer comprises:
a load analyzer configured to calculate the load of the input data; and
a grayscale analyzer configured to extract the peak grayscale from the input data.

7. The display device of claim 5, wherein the current sensor is configured to supply an alarm signal to the code value generator when the global current value exceeds a limit current value.

8. The display device of claim 7, wherein the code value generator is configured to decrease a voltage of the first driving power source when the alarm signal is input from the current sensor.

9. The display device of claim 5, wherein the controller is configured to:
generate a first level control signal when the voltage code is the threshold voltage code or higher; and
generate a second level control signal when the voltage code is lower than the threshold voltage code.

10. The display device of claim 9, wherein the power generator comprises:
a digital-to-analog converter configured to generate a reference voltage corresponding to the voltage code;
the DC-to-DC converter configured to generate the first driving power source based on the reference voltage;
a first resistor, and a second resistor having a lower resistance value as compared with that of the first resistor; and
a selector configured to electrically connect the first resistor to the DC-to-DC converter or the second resistor to the DC-to-DC converter corresponding to the first level control signal or the second level control signal.

11. The display device of claim 10, wherein the selector is configured to electrically connect the first resistor to the DC-to-DC converter when the first level control signal is input, and
wherein the DC-to-DC converter is configured to be driven at a first switching frequency when the first resistor is connected thereto.

12. The display device of claim 11, wherein the selector is configured to electrically connect the second resistor to the DC-to-DC converter when the second level control signal is input, and
wherein the DC-to-DC converter is configured to be driven at a second switching frequency higher than the first switching frequency when the second resistor is connected thereto.

13. A method of driving a display device, comprising:
generating a voltage code corresponding to a load of input data and a peak grayscale;
comparing the voltage code with a threshold voltage code;
generating a first level control signal or a second level control signal based on a comparison result of the voltage code with the threshold voltage code; and
generating, by a DC-to-DC converter, a first driving power source corresponding to the voltage code at different switching frequencies corresponding to the first level control signal or the second level control signal.

14. The method of claim 13, wherein the threshold voltage code corresponds to a voltage value of 80% or more when a highest voltage value of the first driving power source is 100%.

15. The method of claim 13, wherein the first level control signal is generated when the voltage code is the threshold voltage code or higher, and the second level control signal is generated when the voltage code is lower than the threshold voltage code.

16. The method of claim 15, wherein the DC-to-DC converter is configured to be driven at a first switching frequency when the first level control signal is input, and
wherein the DC-to-DC converter is configured to be driven at a second switching frequency when the second level control signal is input.

17. The method of claim 16, wherein the second switching frequency is higher than the first switching frequency.

18. The method of claim 16, wherein the DC-to-DC converter is configured to be electrically connected to a first resistor when the first level control signal is input, and
wherein the DC-to-DC converter is configured to be electrically connected to a second resistor when the second level control signal is input, the second resistor having a resistance value lower than a resistance value of the first resistor.

19. An electronic device comprising:
a display panel comprising pixels;
a DC-to-DC converter configured to supply a first driving power source to the display panel based on a voltage code; and
a controller configured to generate the voltage code based on input data,
wherein the controller is further configured to compare the voltage code with a threshold voltage code, and
wherein a switching frequency of the DC-to-DC converter is changed based on a comparison result of the voltage code and the threshold voltage code.

20. The electronic device of claim 19, wherein the DC-to-DC converter is configured to be driven at a first switching frequency when the voltage code is the threshold voltage code or higher,
wherein the DC-to-DC converter is configured to be driven at a second switching frequency when the voltage code is lower than the threshold voltage code, and
wherein the second switching frequency is higher than the first switching frequency.
